(19) United States
(12) Patent Application Publication
(10) Pub. No.: US 2013/0321497 A1
(43) Pub. Date: Dec. 5, 2013

(54) Method of Signal Compensation, Transformation Circuit in Liquid Crystal Panel, and Liquid Crystal Display Device

(71) Applicant: Chih-tsung Kang, Shenzhen (CN)

(72) Inventor: Chih-tsung Kang, Shenzhen (CN)

(73) Assignee: SHENZHEN CHINA STAR OPTOELECTRONICS TECHNOLOGY CO., LTD., Shenzhen,Guangdong (CN)

(21) Appl. No.: 13/574,612

(22) PCT Filed: Jun. 12, 2012
(86) PCT No.: PCT/CN2012/076745

§ 371 Date: Jul. 22, 2012

(30) Foreign Application Priority Data
Jun. 5, 2012 (CN) 201210183068.9

(51) Int. Cl. G09G 3/36; G09G 5/02; G09G 5/00

(52) U.S. Cl. 345/694; 345/204; 345/87

(57) ABSTRACT

The present invention provides a method of signal compensation in view area of liquid crystal panel, which includes: inputting respective display drive signal of each pixel of view area of liquid crystal panel; performing compensation on respective display drive signal of each pixel in boundary area of view area of liquid crystal panel, or performing compensation on respective display drive signal of each pixel area outside of view area boundary of liquid crystal panel; and outputting respective compensated and uncompensated display drive signal of each pixel to each respective pixel. The present invention also provides an input data transformation circuit for liquid crystal panel and a liquid crystal display device. As such, the present invention can improve overall optical uniformity of view area of liquid crystal panel.

### BACKGROUND OF THE INVENTION

1. Field of the Invention

The present invention relates to the field of liquid crystal displaying techniques, and in particular to a method of signal compensation in view area of liquid crystal panel, input data transformation circuit of liquid crystal panel and liquid crystal display device.

2. The Related Arts

Liquid crystal display usually comprises a liquid crystal panel, and the liquid crystal panel further comprises an array substrate, a color film substrate and a liquid crystal layer sandwiched between array substrate and color film substrate. Liquid crystal display device comprises a plurality of pixels forming the view area. Each pixel comprises pixel electrode disposed on array substrate and common electrode disposed on color film substrate. The pixel electrode and common electrode on color film substrate form liquid crystal capacitor. Liquid crystal display device usually further comprises control circuit for controlling pixel electrode, data IC and scan IC.

As shown in FIG. 1, liquid crystal panel comprises view area and seal coating area 101. View area comprises view A area 102 and view B area 103. During the LCD cell process, seal 101 must be coated over area surrounding view area of liquid crystal panel to make array substrate and color film substrate pressed together. Because conditions of cell process are not easy to control and many factors will affect gap uniformity after array substrate and color film substrate are pressed together, the overall optical uniformity of liquid crystal panel is affected, which usually leads to the result that gap of view area closer to seal will be larger than gap of view area farther from seal. In other words, view A area 102 close to seal has a higher optical transmittance, while view B area 103 farther from seal has a lower optical transmittance. The display quality observed is that view A area 102 displays a mura quality with respect to view B area 103. Hence, the overall optical uniformity of liquid crystal panel is affected.

### SUMMARY OF THE INVENTION

The technical issue to be addressed by the present invention is to provide a method of signal compensation in view area of liquid crystal panel, input data transformation circuit of liquid crystal panel and liquid crystal display device to improve overall optical uniformity of view area of liquid crystal panel.

The present invention provides a method of signal compensation in view area of liquid crystal panel, which comprises: inputting respective display drive signal of each pixel of view area of liquid crystal panel; performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and outputting respective compensated and uncompensated display drive signal of each pixel to each respective pixel.

According to a preferred embodiment of the present invention, prior to the step of performing compensation on respective display drive signal of each pixel in boundary area of view area of liquid crystal panel, or performing compensation on respective display drive signal of each pixel area outside of view area boundary of liquid crystal panel, performing: based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q; determining whether column number i and row number j of pixel requiring compensation of drive signal being in boundary area or outside of boundary area, i and j being natural number; if n<i<m and p<j<q, the pixel requiring compensation of drive signal being in area outside of view area boundary of liquid crystal panel; otherwise, the pixel requiring compensation of drive signal being in boundary area of view area of liquid crystal panel; repeating the above loop to determine each pixel of view area of liquid crystal panel being in boundary area or outside of boundary area.

According to a preferred embodiment of the present invention, the step of performing compensation on respective display drive signal of each pixel in boundary area of view area of liquid crystal panel comprises specifically: based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

The present invention provides an input data transformation circuit of liquid crystal panel, which comprises: an input module, for inputting display drive signal of each pixel of view area of liquid crystal panel; signal compensation module, for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and an output module, for outputting respective compensated and uncompensated display drive signal of each pixel to each respective pixel.

According to a preferred embodiment of the present invention, the input data transformation circuit further comprises a determination module, the determination module comprises: an ensuring unit, for, based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q; a determination unit, for determining whether column number i and row number j of pixel requiring compensation of drive signal being in boundary area or outside of boundary area, i and j being natural number; a division unit, if n<i<m and p<j<q, the pixel requiring compensation of drive signal being in area outside of view area boundary of liquid crystal panel; otherwise, the pixel requiring compensation of drive signal being in boundary area of view area of liquid crystal panel and returning to determination unit, for repeating the above loop to determine each pixel of view area of liquid crystal panel being in boundary area or outside of boundary area.

According to a preferred embodiment of the present invention, the signal compensation module is specifically applied to, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

The present invention provides a liquid crystal display device, which comprises: input data transformation circuit, data drive control circuit, output data format circuit, liquid crystal polarity control circuit, scan drive control circuit and synchronization circuit; the synchronization circuit being electrically connected to data drive control circuit and liquid crystal polarity control circuit, the data drive control circuit being electrically connected to output data format circuit; the input data transformation circuit comprising: an input module, for inputting display drive signal of each pixel of view area of liquid crystal panel; signal compensation module, for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and an output module, for outputting respective compensated and uncompensated display drive signal of each pixel to each respective pixel.

According to a preferred embodiment of the present invention, the input data transformation circuit further comprises a determination module, the determination module comprises: an ensuring unit, for, based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q; a determination unit, for determining whether column number i and row number j of pixel corresponding to drive signal inputted by input module being in boundary area or outside of boundary area, i and j being natural number; a division unit, if n<i<m and p<j<q, the pixel requiring compensation of drive signal being in area outside of view area boundary of liquid crystal panel; otherwise, the pixel requiring compensation of drive signal being in boundary area of view area of liquid crystal panel and returning to determination unit, for repeating the above loop to determine each pixel of view area of liquid crystal panel being in boundary area or outside of boundary area.

According to a preferred embodiment of the present invention, the signal compensation module is specifically applied to, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel:

The efficacy of the present invention is that to be distinguished from the state of the art. The present invention, before outputting display drive signal to respective pixel, performs signal compensation on display drive signal of each pixel of boundary area of view area or area outside of view area boundary, and then outputs compensated and uncompensated respective display drive signal of each pixel to respective pixel. Because of performing signal compensation on the optically non-uniform area of view area, the present invention can improve overall optical uniformity of the view area of liquid crystal panel, achieve the objective of image quality uniformity improvement of liquid crystal panel.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the appearance difference between boundary area and area outside of view area boundary in a known technique;

FIG. 2 is a flowchart of a first embodiment of signal compensation method of view area of liquid crystal panel according to the present invention;

FIG. 3 is a flowchart of a second embodiment of signal compensation method of view area of liquid crystal panel according to the present invention;

FIG. 4 is a flowchart of a third embodiment of signal compensation method of view area of liquid crystal panel according to the present invention;

FIG. 5 is a flowchart of a fourth embodiment of signal compensation method of view area of liquid crystal panel according to the present invention;

FIG. 6 is a flowchart of a fifth embodiment of signal compensation method of view area of liquid crystal panel according to the present invention;

FIG. 7 is a flowchart of a sixth embodiment of signal compensation method of view area of liquid crystal panel according to the present invention;

FIG. 8 is a schematic view showing an actual division of view area of the signal compensation method of view area of liquid crystal panel according to the present invention;

FIG. 9 is a schematic view showing the structure of a first embodiment of the input data transformation circuit of liquid crystal panel according to the present invention;

FIG. 10 is a schematic view showing the structure of a second embodiment of the input data transformation circuit of liquid crystal panel according to the present invention; and

FIG. 11 is a schematic view showing an embodiment of the liquid crystal display device according to the present invention.

### DETAILED DESCRIPTION OF THE PREFERRED EMBODIMENTS

The following description refers drawings and embodiments of the present invention.

Referring to FIG. 2, FIG. 2 is a flowchart of a first embodiment of signal compensation method of view area of liquid crystal panel according to the present invention, which comprises:

Step S201: inputting respective display drive signal of each pixel of view area of liquid crystal panel.

Each point, i.e., each pixel, on liquid crystal panel of a general color display at least comprises three sub-pixels, R, G, B. In this step, inputting respective display drive signal of each pixel of view area of liquid crystal panel can be inputting, for example, grayscale signal of RBG of each pixel.

Step S202: performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel.

Based on optical uniformity, view area of liquid crystal panel is divided into view area boundary area and area outside of view area boundary. To make image quality consistent for both view area boundary area and area outside of view area boundary, one of the two following options is used:

A: performing compensation on respective display drive signal of each pixel in boundary area of view area of liquid crystal panel, so as to make image quality of boundary area of view area of liquid crystal panel consistent with image quality area outside of view area boundary of liquid crystal panel.

B: performing compensation on respective display drive signal of each pixel area outside of view area boundary of liquid crystal panel, so as to make image quality of boundary area of view area of liquid crystal panel consistent with image quality area outside of view area boundary of liquid crystal panel.

Both of the above options can achieve the objective of making image quality of boundary area of view area of liquid crystal panel consistent with image quality area outside of view area boundary of liquid crystal panel.

Step S203: outputting respective compensated and uncompensated display drive signal of each pixel to each respective pixel.

When performing compensation on respective display drive signal of each pixel in boundary area of view area of liquid crystal panel, the outputted signals are compensated display drive signal of each pixel of boundary area of view area of liquid crystal panel and uncompensated display drive signal of each pixel of area outside of view area boundary. When performing compensation on respective display drive signal of each pixel area outside of view area boundary of liquid crystal panel, the outputted signals are uncompensated display drive signal of each pixel of boundary area of view area of liquid crystal panel and compensated display drive signal of each pixel of area outside of view area boundary.

Therefore, it is understood that before outputting display drive signal of each pixel to each respective pixel, the present invention can compensate display drive signal of each pixel in boundary area of view area of liquid crystal panel or area outside of view area boundary of liquid crystal panel, and then outputs respective compensated and uncompensated display drive signal of each pixel to each respective pixel so as to make image quality of boundary area of view area of liquid crystal panel consistent with image quality area outside of view area boundary of liquid crystal panel.

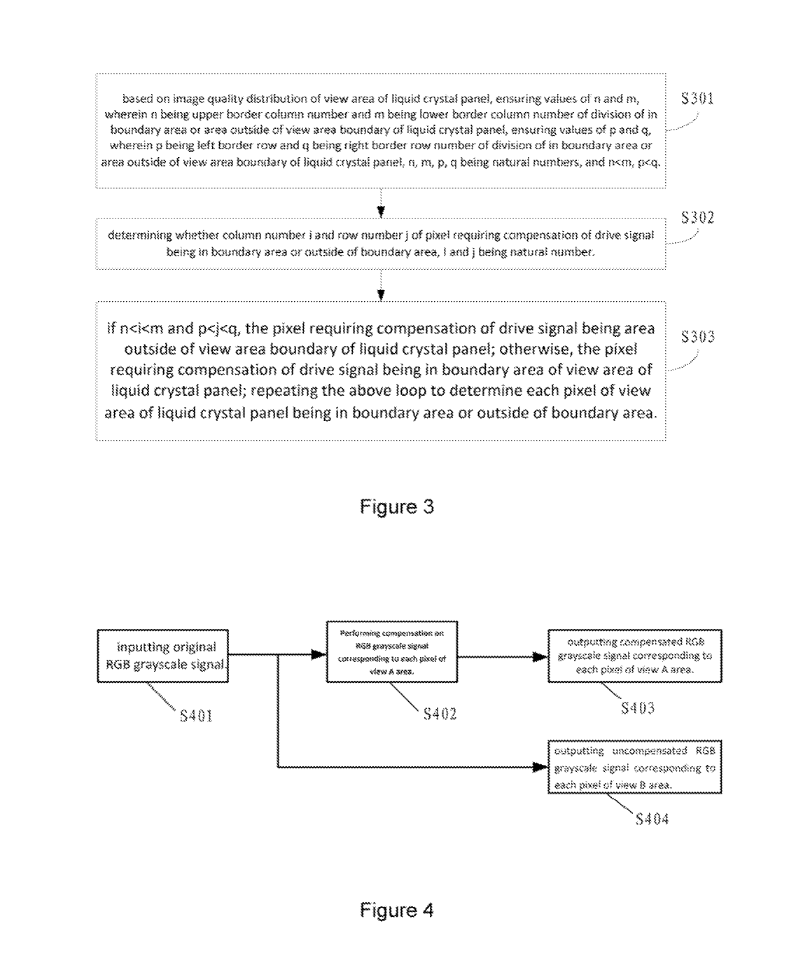

Referring to FIG. 3, FIG. 3 is a flowchart of a second embodiment of signal compensation method of view area of liquid crystal panel according to the present invention. The instant embodiment is similar to the first embodiment, except that the following steps are performed prior to step S202:

Step S301: based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q.

Through circuit, it is easier to ensure the upper border column n, the lower border column m, the left border row p and the right border row q, which leads to know what area any column i and row j is located in and know what to perform on the pixels. For example, in an embodiment, the upper border column n, the lower border column m, the left border row p and the right border row q are ensured to be 5, 103, 5 and 212 respectively. In other words, the division between the two areas is: the upper border column 5, the lower border column 103, the left border row 5 and the right border row 212.

Step S302: determining whether column number i and row number j of pixel requiring compensation of drive signal being in boundary area or outside of boundary area, i and j being natural number.

Step S303: if n<i<m and p<j<q, the pixel requiring compensation of drive signal being area outside of view area boundary of liquid crystal panel; otherwise, the pixel requiring compensation of drive signal being in boundary area of view area of liquid crystal panel; repeating the above loop to determine each pixel of view area of liquid crystal panel being in boundary area or outside of boundary area.

According to the above example, the division between the two areas is: the upper border column 5, the lower border column 103, the left border row 5 and the right border row 212. If the column i and row j of pixel requiring display drive signal compensation are 6 and 100 respectively, i. e., the pixel is located at 6^{th} column and 100^{th} row, the result of step S303 is: the pixel is in area outside of view area boundary. Another pixel requiring display drive signal compensation is located at 4^{th} column and 227^{th} row, the result of step S303 is: the pixel is in boundary area of view area.

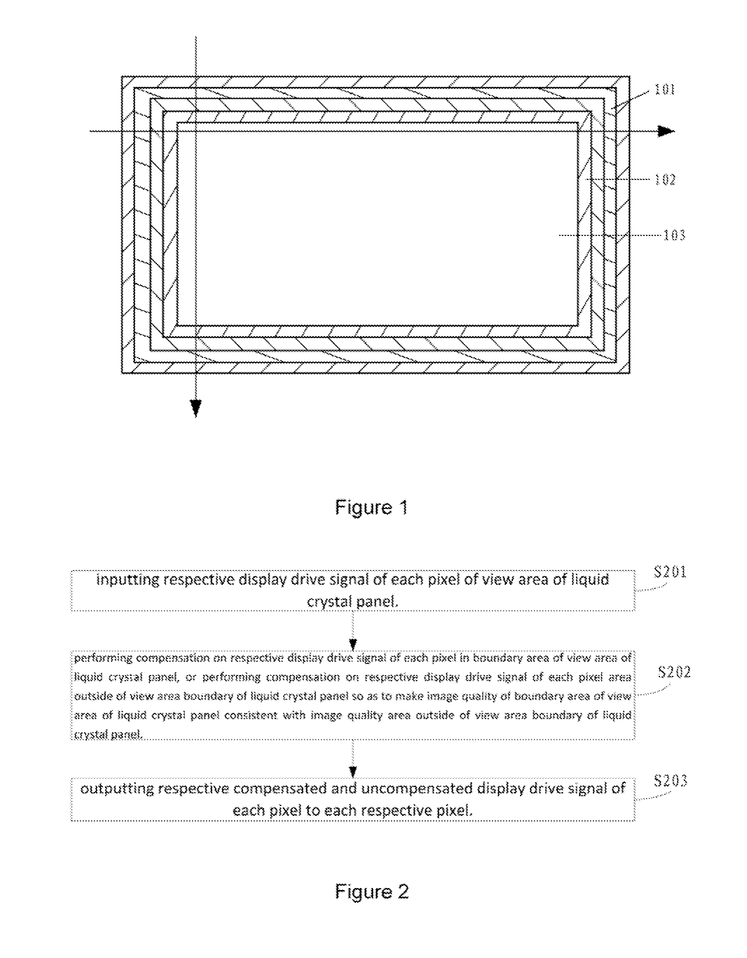

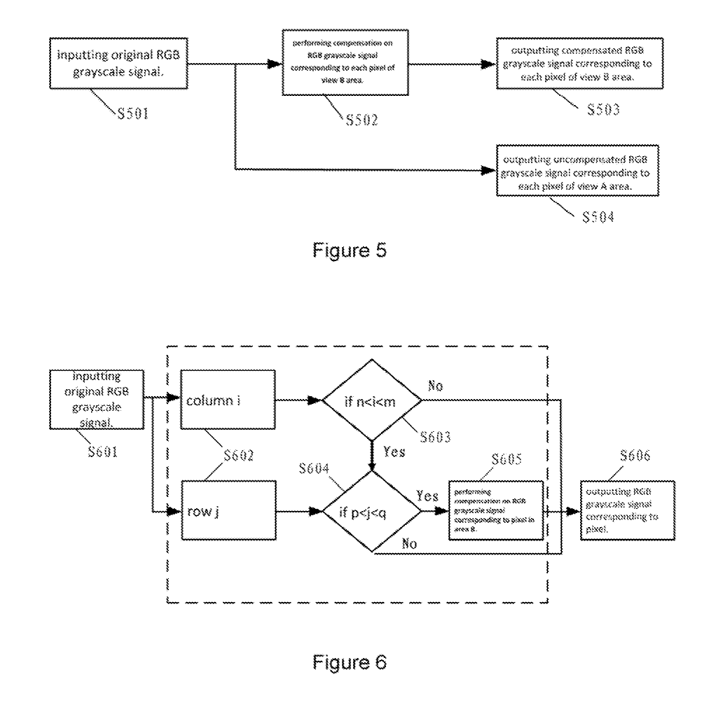

Referring to FIG. 4 and FIG. 5, FIG. 4 and FIG. 5 are flowcharts of a third and a fourth embodiment of signal compensation method of view area of liquid crystal panel according to the present invention, respectively. These two embodiments are similar to the first embodiment, and are specific realization of the first embodiment, corresponding to two options, wherein area A corresponds to view A area 102 of FIG. 1, i.e., boundary area of view area, and area B corresponds to view B area 103 of FIG. 1, i.e., area outside of view area boundary.

Option 1:

Step S401: inputting original RGB grayscale signal corresponding to each pixel of view area, i.e., display drive signal.

Step S402: performing compensation on RGB grayscale signal corresponding to each pixel of view A area.

Step S403: outputting compensated RGB grayscale signal corresponding to each pixel of view A area.

Step S404: outputting uncompensated RGB grayscale signal corresponding to each pixel of view B area.

Option 2: in comparison with option 1, the difference is to perform signal compensation on different signals. Step S501 is the same as Step S401.

Step S502: performing compensation on RGB grayscale signal corresponding to each pixel of view B area.

Step 503: outputting compensated RGB grayscale signal corresponding to each pixel of view B area.

Step S504: outputting uncompensated RGB grayscale signal corresponding to each pixel of view A area.

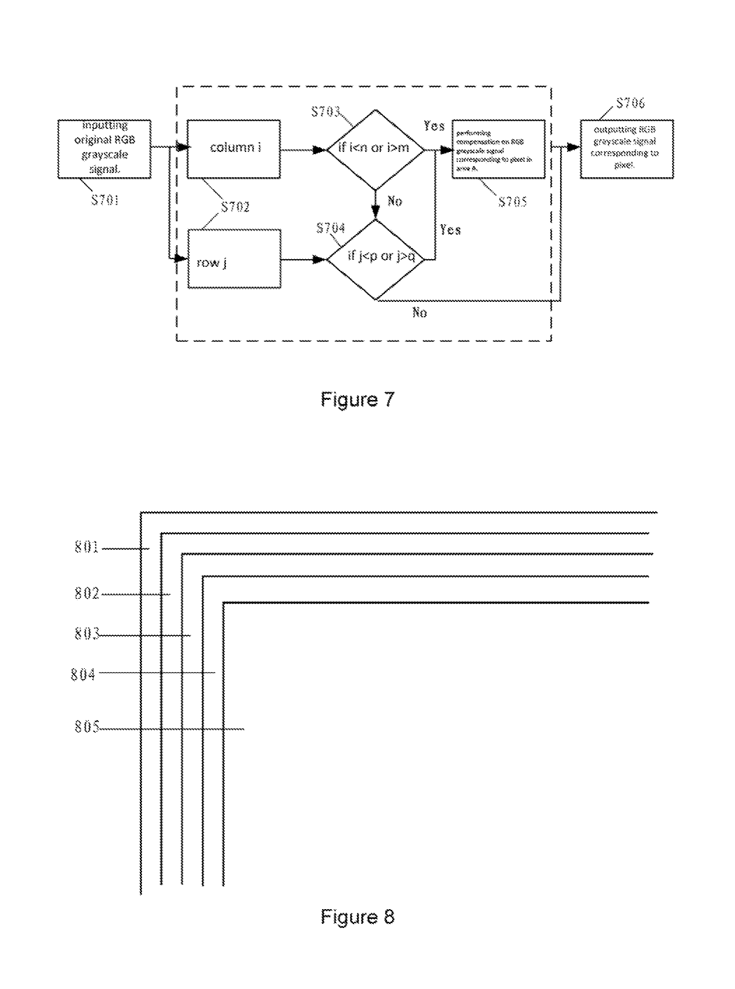

Referring to FIG. 6 and FIG. 7, FIG. 6 and FIG. 7 are flowcharts of a fifth and a sixth embodiment of signal compensation method of view area of liquid crystal panel according to the present invention respectively, wherein area A corresponds to view A area 102 of FIG. 1, i.e., boundary area of view area, and area B corresponds to view B area 103 of FIG. 1, i.e., area outside of view area boundary. The method comprises the following steps:

Step S601: inputting original RGB grayscale signal corresponding to a pixel of view area, i.e., display drive signal.

Step S602: ensuring the column number i and row number j of the pixel.

Step S603: determining whether n<i<m; if so, proceed to step S604; otherwise, proceed to step S606.

Step S604: determining whether p<j<q; if so, proceed to step S605; otherwise proceed to step S606.

If n<i<m and p<j<q, the pixel requiring compensation of drive signal is area outside of view area boundary of liquid crystal panel, i.e., view B area; otherwise, the pixel requiring compensation of drive signal is in boundary area of view area, i.e., view A area.

Step S605: performing compensation on RGB grayscale signal corresponding to pixel in area B.

Step S606: outputting uncompensated RGB grayscale signal corresponding to pixel in area A or outputting compensated RGB grayscale signal corresponding to pixel in area B.

If the pixel is in view B area, compensated RGB grayscale signal of the pixel is outputted. If the pixel is in view A area, uncompensated RGB grayscale signal of the pixel is outputted.

The difference between FIG. 7 and FIG. 6 is that FIG. 7 performs compensation on RGB grayscale signal corresponding to pixel in area A, wherein steps S701 and S702 are the same as steps S601 and S602 respectively. The different steps are specifically as following:

Step S703: whether i<n or i>m; if so, proceed to step S705; otherwise, proceed to step S704.

Step S704: determining whether j<p or j>q; if so, proceed to step S705; otherwise proceed to step S706.

Steps S703 and S704 are to determine whether the pixel is in view A area or view B area. If the pixel is in view A area, signal compensation is performed on the RGB grayscale signal of the pixel. If the pixel is in view B area, no signal compensation is performed on the RGB grayscale signal of the pixel.

Step S705: performing compensation on RGB grayscale signal corresponding to pixel in area A.

Step S706: outputting uncompensated RGB grayscale signal corresponding to pixel in area B or outputting compensated RGB grayscale signal corresponding to pixel in area A.

If the pixel is in view A area, compensated RGB grayscale signal of the pixel is outputted. If the pixel is in view B area, uncompensated RGB grayscale signal of the pixel is outputted.

In short, because signal compensation is performed on optically non-uniform area of view area, the overall optical uniformity of the view area of liquid crystal panel is improved, and the objective of image quality uniformity improvement of liquid crystal panel is achieved.

According to the second embodiment of the method of the present invention, step 202 specifically comprises: based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel. FIG. 8 shows an example.

Referring to FIG. 8, FIG. 8 is a schematic view showing an actual division of view area of the signal compensation method of view area of liquid crystal panel according to the present invention. Take the left upper corner of liquid crystal panel as example for description. i and j are column and row numbers of a pixel respectively.

According to image quality distribution of view area of liquid crystal panel, the upper border column n dividing boundary area and area outside of view area boundary on liquid crystal panel is ensure, and the left border row p dividing boundary area and area outside of view area boundary on liquid crystal panel is ensure.

Under a default display uniform luminance of an image, the boundary area of view area of upper left corner above upper border column n is divided into four areas 801, 802, 803 and 804 based on actual luminance of view area visible to the user, i.e., [1, a], [a+1, a+b], [a+b+1, a+b+c], [a+b+c+1, a+b+c+d]. Similarly, the boundary area of view area of upper left corner left to left border column p is divided into four areas 801, 802, 803 and 804 based on actual luminance of view area visible to the user, i.e., [1, r], [r+1, r+s], [r+s+1, r+s+t], [r+s+t+1, r+s+t+u]. a, b, c, d, r, s, t, u are all natural numbers, and a+b+c+d+1=n, r+s+t+u+1=p. Number of areas is not necessarily four. Any other number of areas can also be divided and used.

Areas 801, 802, 803, 804 of boundary area of view area and area 805 outside of view area boundary have different luminance to the user under a default display uniform luminance of an image. Under a default display uniform luminance of an image, i.e., display signals G1, G2, G3, G4 and G5 supplied to the five areas are the same grayscale voltage signal, in other words, G1=G2=G3=G4=G5. The corresponding actual luminance is L1, L2, L3, L4 and L5 respectively. The actual luminance is different and may show a gradual change: L1>L2>L3>L4>L5. To compensate the difference, options of FIG. 6 and FIG. 7 can be used. Display signal G1 of area 801 (i.e., column i=[1, a], row j=[1, r]) is compensated with G1′. Display signal G2 of area 802 (i.e., column i=[a+1, a+b], row j=[r+1, r+s]) is compensated with G2′. Display signal G3 of area 803 (i.e., column i=[a+b+1, a+b+c], row j=[r+s+1, r+s+t]) is compensated with G3′. Display signal G4 of area 804 (i.e., column i=[a+b+c+1, a+b+c+d], row j=[r+s+t+1, r+s+t+u]) is compensated with G4′. Display signal G5 of area 805 (i.e., area outside of boundary i>a+b+c+d, J>r+s+t+u) is compensated with G5′. G1′<G2′<G3′<G4′<G5′ or G1′>G2′>G3′>G4′>G5′. As such, actual luminance of five areas are basically the same, i.e., L1′=L2′=L3′=L4′=L5′.

In this manner, the uniformity of the overall liquid crystal panel is improved and difficulty of process is reduced.

Referring to FIG. 9, FIG. 9 is a schematic view showing the structure of a first embodiment of the input data transformation circuit of liquid crystal panel according to the present invention. The input data transformation circuit comprises: input module 901, signal compensation module 902 and output module 903.

Input module 901 is for inputting display drive signal of each pixel of view area of liquid crystal panel.

Signal compensation module 902 is for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel.

Output module 903 is for outputting respective compensated and uncompensated display drive signal of each pixel to each respective pixel.

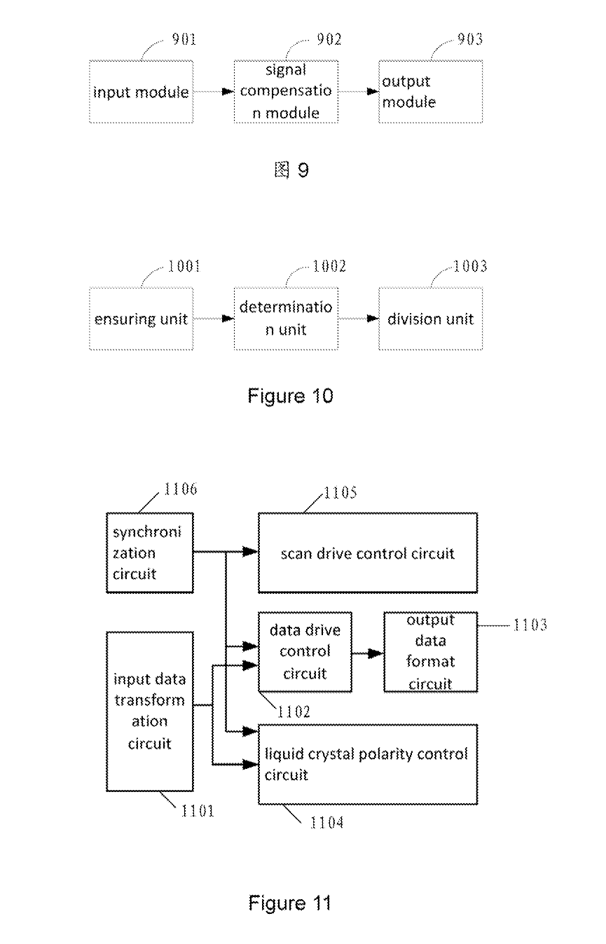

Referring to FIG. 10, FIG. 10 is a schematic view showing the structure of a second embodiment of the input data transformation circuit of liquid crystal panel according to the present invention. The present embodiment is similar to the first embodiment, except that: the input data transformation circuit further comprises a determination module, and the determination module further comprises: an ensuring unit 1001, a determination unit 1002 and a division unit 1003.

Ensuring unit 101 is for, based on image quality distribution of view area of liquid crystal panel, ensuring values of n and m, wherein n is upper border column number and m is lower border column number of division of in boundary area or area outside of view area boundary of liquid crystal panel, ensuring values of p and q, wherein p is left border row and q is right border row number of division of in boundary area or area outside of view area boundary of liquid crystal panel, n, m, p, q are natural numbers, and n<m, p<q.

Determination unit 1102 is for determining whether column number i and row number j of pixel requiring compensation of drive signal is in boundary area or outside of boundary area, i and j are natural number.

Division unit 1003 is for, if n<i<m and p<j<q, dividing the pixel requiring compensation of drive signal into area outside of view area boundary of liquid crystal panel; otherwise, dividing the pixel requiring compensation of drive signal into boundary area of view area of liquid crystal panel and returning to determination unit, for repeating the above loop to determine each pixel of view area of liquid crystal panel being in boundary area or outside of boundary area.

According to the second embodiment of the input data transformation circuit of the present invention, signal compensation module 902 specifically is for, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

The present invention, before outputting display drive signal to respective pixel, performs signal compensation on display drive signal of each pixel of boundary area of view area or area outside of view area boundary, and then outputs compensated and uncompensated respective display drive signal of each pixel to respective pixel. Because of performing signal compensation on the optically non-uniform area of view area, the present invention can improve overall optical uniformity of the view area of liquid crystal panel, achieve the objective of image quality uniformity improvement of liquid crystal panel.

The present invention further provides a liquid crystal display device, as shown in FIG. 11. The liquid crystal display device comprises: input data transformation circuit 1101, data drive control circuit 1102, output data format circuit 1103, liquid crystal polarity control circuit 1104, scan drive control circuit 1105 and synchronization circuit 1106.

Synchronization circuit 1106 is electrically connected to data drive control circuit 1102 and liquid crystal polarity control circuit 1104. Data drive control circuit 1102 is electrically connected to output data format circuit 1103.

Input data transformation circuit 1101 comprises: an input module, signal compensation module and output module.

The input module is for inputting display drive signal of each pixel of view area of liquid crystal panel.

The signal compensation module is for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel.

The output module is for outputting respective compensated and uncompensated display drive signal of each pixel to data drive control circuit 1102 and liquid crystal polarity control module 1104.

Input data transformation circuit 1101 further comprises a determination module, and the determination module comprises:

An ensuring unit is for, based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q.

A determination unit is for determining whether column number i and row number j of pixel requiring compensation of drive signal being in boundary area or outside of boundary area, i and j being natural number.

A division unit is, if n<i<m and p<j<q, for dividing the pixel requiring compensation of drive signal into area outside of view area boundary of liquid crystal panel; otherwise, dividing the pixel requiring compensation of drive signal into boundary area of view area of liquid crystal panel and returning to determination unit, for repeating the above loop to determine each pixel of view area of liquid crystal panel being in boundary area or outside of boundary area.

In the instant embodiment, the signal compensation module is specifically applied to, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

In summary, the present invention, before outputting display drive signal to respective pixel, performs signal compensation on display drive signal of each pixel of boundary area of view area or area outside of view area boundary, and then outputs compensated and uncompensated respective display drive signal of each pixel to respective pixel. Because of performing signal compensation on the optically non-uniform area of view area, the present invention can improve overall optical uniformity of the view area of liquid crystal panel, achieve the objective of image quality uniformity improvement of liquid crystal panel.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the claims of the present invention.

What is claimed is:

1. A method of signal compensation in view area of liquid crystal panel, which comprises:
inputting respective display drive signal of each pixel of view area of liquid crystal panel;
based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q;
determining whether column number i and row number j of pixel requiring compensation of drive signal being in boundary area or outside of boundary area, I and j being natural number;
if n<i<m and p<j<q, the pixel requiring compensation of drive signal being in area outside of view area boundary of liquid crystal panel; otherwise, the pixel requiring compensation of drive signal being in boundary area of view area of liquid crystal panel;
performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and
outputting respective compensated and uncompensated display drive signal of each pixel to each respective pixel.

2. The method as claimed in claim 1, characterized in that the step of performing compensation on respective display drive signal of each pixel in boundary area of view area of liquid crystal panel comprises specifically:
based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

3. An input data transformation circuit of liquid crystal panel, which comprises:
an input module, for inputting display drive signal of each pixel of view area of liquid crystal panel;
a signal compensation module, for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and
an output module, for outputting respective compensated and uncompensated display drive signal of each pixel to each respective pixel.

4. The circuit as claimed in claim 3, characterized in that the input data transformation circuit further comprises a determination module, the determination module comprises:
an ensuring unit, for, based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p, q being natural numbers, and n<m, p<q;
a determination unit, for determining whether column number i and row number j of pixel requiring compensation of drive signal being in boundary area or outside of boundary area, i and j being natural number;
a division unit, if n<i<m and p<j<q, the pixel requiring compensation of drive signal being in area outside of view area boundary of liquid crystal panel; otherwise, the pixel requiring compensation of drive signal being in boundary area of view area of liquid crystal panel and returning to determination unit, for repeating the above loop to determine each pixel of view area of liquid crystal panel being in boundary area or outside of boundary area.

5. The circuit as claimed in claim 4, characterized in that the signal compensation module is specifically applied to, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.

6. A liquid crystal display device, which comprises:
an input data transformation circuit, a data drive control circuit, an output data format circuit, a liquid crystal polarity control circuit, a scan drive control circuit and a synchronization circuit; the synchronization circuit being electrically connected to data drive control circuit and liquid crystal polarity control circuit, the data drive control circuit being electrically connected to output data format circuit;
the input data transformation circuit comprising:
an input module, for inputting display drive signal of each pixel of view area of liquid crystal panel;
a signal compensation module, for performing compensation on respective display drive signal of each pixel in boundary area of view area of liquid crystal panel, or performing compensation on respective display drive signal of each pixel area outside of view area boundary of liquid crystal panel so as to make image quality of boundary area of view area of liquid crystal panel consistent with image quality area outside of view area boundary of liquid crystal panel; and
an output module, for outputting respective compensated and uncompensated display drive signal of each pixel to each respective pixel.

7. The liquid crystal display device as claimed in claim 6, characterized in that the input data transformation circuit further comprises a determination module, the determination module comprises:
an ensuring unit, for, based on image quality distribution of view area of liquid crystal panel, ensuring values of n and m, wherein n being upper border column number and m being lower border column number of division of in boundary area or area outside of view area boundary of liquid crystal panel, ensuring values of p and q, wherein p being left border row and q being right border row number of division of in boundary area or area outside of view area boundary of liquid crystal panel, n, m, p; q being natural numbers, and n<m, p<q;
a determination unit, for determining whether column number i and row number j of pixel corresponding to the drive signal inputted by the input module being in boundary area or outside of boundary area, i and j being natural number;
a division unit, if n<i<m and p<j<q, the pixel requiring compensation of drive signal being in area outside of view area boundary of liquid crystal panel; otherwise, the pixel requiring compensation of drive signal being in boundary area of view area of liquid crystal panel and returning to determination unit, for repeating the above loop to determine each pixel of view area of liquid crystal panel being in boundary area or outside of boundary area.

8. The liquid crystal display device as claimed in claim 7, characterized in that the signal compensation module is specifically applied to, based on luminance of view area of liquid crystal panel, dividing boundary area of view area of liquid crystal panel ensured by upper border column number n, lower border column number m, left border row number p and right border row number q into two or more areas, inputting two or more compensation signals corresponding to two or more areas so that two or more areas displaying a same default uniform luminance as area outside of view area boundary of liquid crystal display panel.
